(19) United States
(12) Patent Application Publication
(10) Pub. No.: US 2019/0004549 A1
(43) Pub. Date: Jan. 3, 2019

(54) MULTI-FUNCTION VALVE CORE WITH DRINKING WATER CONTROL FUNCTION

(71) Applicant: Zhejiang Mingdi ceramic valve Co., Ltd., Zhejiang (CN)

(72) Inventor: Lijuan ZHAO, Zhejiang (CN)

(21) Appl. No.: 15/948,127

(22) Filed: Apr. 9, 2018

(30) Foreign Application Priority Data
Jul. 3, 2017 (CN) 201710544568.3

(51) Int. Cl. G05D 23/13

(52) U.S. Cl. CPC G05D 23/1313

(57) ABSTRACT

The invention discloses a multi-function valve core with a drinking water control function, which comprises a housing, an upper cover, a handle, a rotor, a drive plate, a movable ceramic disc and a stationary ceramic disc, wherein the housing and the stationary ceramic disc are respectively provided with a hot water inlet hole, a cold water inlet hole, a mixed cold and hot water outlet hole, a drinking water inlet hole and a drinking water outlet hole at corresponding positions, and the movable ceramic disc is provided with a first cavity and a second cavity. In this technical solution, the functions of two valve cores are integrated as a whole, thus simplifying the product structure.

### FIELD OF THE INVENTION

The invention relates to a valve core, and particularly to a multi-function valve core with a drinking water control function.

### BACKGROUND OF THE INVENTION

There are two kinds of drinking water faucets for kitchens on the market. One kind of such faucets are controlled by two valve cores, the left valve core is configured to separately control the drinking water faucet, and the right valve core is configured to control cold and hot water such that the product has a complex design and higher cost and is not convenient to use. The other kind of such faucets are characterized in that: two valve cores are integrated as a whole, but such valve core can only be rotated in one plane, cold water is discharged when the valve core is opened, cold and hot water are gradually mixed together with an increase in the rotation angle until complete hot water is discharged, the flow rate cannot be adjusted at the same water outlet temperature, and the discharge of complete cold water cannot be controlled.

### SUMMARY OF THE INVENTION

For the disadvantages of the prior art, a technical problem to be solved by the invention is to provide a multi-function valve core with a drinking water control function.

To achieve the above object, the invention employs the following measures.

A multi-function valve core with a drinking water control function comprises a housing, an upper cover, a handle, a rotor, a drive plate, a movable ceramic disc and a stationary ceramic disc, wherein the housing and the upper cover are clamped together by a clamping buckle to form a housing assembly of the valve core, the handle, the rotor, the drive plate, the movable ceramic disc and the stationary ceramic disc are mounted in the housing assembly, a lower end of the handle is mounted in the rotor, the handle is connected with the rotor via a pin, an upper end of the handle protrudes from a cover hole in the middle of the upper cover, the rotor is connected with the drive plate, the drive plate and the movable ceramic disc are clamped together, the stationary ceramic disc is mounted below the movable ceramic disc, the stationary ceramic disc is clamped into the housing, the housing and the stationary ceramic disc are respectively provided with a hot water inlet hole, a cold water inlet hole, a mixed cold and hot water outlet hole, a drinking water inlet hole and a drinking water outlet hole at corresponding positions, the movable ceramic disc is provided with a first cavity and a second cavity, the first cavity is communicated with the drinking water inlet hole and the drinking water outlet hole, the second cavity is communicated with the hot water inlet hole, the cold water inlet hole and the mixed cold and hot water outlet hole, the drive plate is provided with a first drive plate limiting surface, a second drive plate limiting surface and a drive plate bar-shaped boss, the rotor is provided with a first rotor limiting surface, a second rotor limiting surface and a rotor bar-shaped clamping slot, the upper cover is provided with a first upper cover limiting surface, a second upper cover limiting surface and a third upper cover limiting surface, and the rotor, the drive plate and the upper cover cooperate with each other to limit the rotation angle of the valve core.

The housing is externally sleeved with an upper O-ring and a lower O-ring and internally provided with three stationary ceramic disc bosses for positioning the stationary ceramic disc, two positioning posts are arranged at the bottom of the housing, a sealing ring assembly is arranged at the bottom of the housing, the housing is internally provided with an inner sealing washer, and the inner sealing washer is placed in a groove inside the housing.

The stationary ceramic disc is provided with stationary ceramic disc positioning slots corresponding to the stationary ceramic disc bosses, the stationary ceramic disc bosses are clamped into the stationary ceramic disc positioning slots, and the shape of the inner sealing washer corresponds to that of the stationary ceramic disc.

The movable ceramic disc is provided with three movable ceramic disc positioning grooves, movable ceramic disc bosses on the drive plate extend into the movable ceramic disc positioning grooves, and the movable ceramic disc is rotated along with the drive plate.

The first drive plate limiting surface cooperates with the second upper cover limiting surface and the second drive plate limiting surface cooperates with the third upper cover limiting surface to limit the rotation angle of the valve core; and the drive plate bar-shaped boss cooperates with the rotor bar-shaped clamping slot, the drive plate is provided with a handle positioning hole, a shifting head on the handle is clamped into the handle positioning hole, and the handle drives the drive plate to move linearly in the rotor bar-shaped clamping slot on the rotor, or to move circularly along with the rotor when driven by the rotor.

The rotor is driven by the handle to move circularly in the cover hole of the upper cover.

The first upper cover limiting surface, the second upper cover limiting surface and the third upper cover limiting surface are located on different planes; and the first upper cover limiting surface cooperates with the first rotor limiting surface, the second upper cover limiting surface cooperates with the second rotor limiting surface, the second upper cover limiting surface cooperates with the first drive plate limiting surface and the third upper cover limiting surface cooperates with the second drive plate limiting surface to limit the rotation angle of the valve core.

The invention has the following beneficial effects: the multi-function valve core is practical and has low production cost and a novel structure, and the functions of two valve cores are integrated as a whole, thus simplifying the product structure.

### BRIEF DESCRIPTION OF THE DRAWINGS

FIG. 1 is a schematic exploded structural view of the invention;

FIG. 2 is a schematic planar structural view of a longitudinal section of the invention;

FIG. 3 is a schematic planar structural view of an upper cover of the invention;

FIG. 4 is a schematic planar structural view of a rotor of the invention;

FIG. 5 is a schematic planar structural view of a drive plate of the invention;

FIG. 6 is a schematic planar structural view of a movable ceramic disc of the invention;

FIG. 7 is a schematic planar structural view of a stationary ceramic disc of the invention;

FIG. 8 is a schematic planar structural view of the bottom of the invention;

FIG. 9 is a schematic planar structural view of the invention in a closed state;

FIG. 10 is a schematic planar structural view of the invention in an opened state;

FIG. 11 is a schematic structural view of the position of the movable ceramic disc and the stationary ceramic disc in a closed state of the invention;

FIG. 12 is a schematic structural view of the position of the movable ceramic disc and the stationary ceramic disc in an opened state of the invention;

FIG. 13 is a schematic structural view of the position of the movable ceramic disc and the stationary ceramic disc at a complete cold water position in an opened state of the invention;

FIG. 14 is a schematic structural view of the position of the movable ceramic disc and the stationary ceramic disc at a complete hot water position in an opened state of the invention;

FIG. 15 is a schematic structural view of the position of the movable ceramic disc and the stationary ceramic disc at a complete hot water position in a closed state of the invention;

FIG. 16 is a schematic structural view of the position of the movable ceramic disc and the stationary ceramic disc at a complete cold water position in a closed state of the invention; and

FIG. 17 is a schematic structural view of the position of the movable ceramic disc and the stationary ceramic disc at a drinking water outlet position in a closed state of the invention.

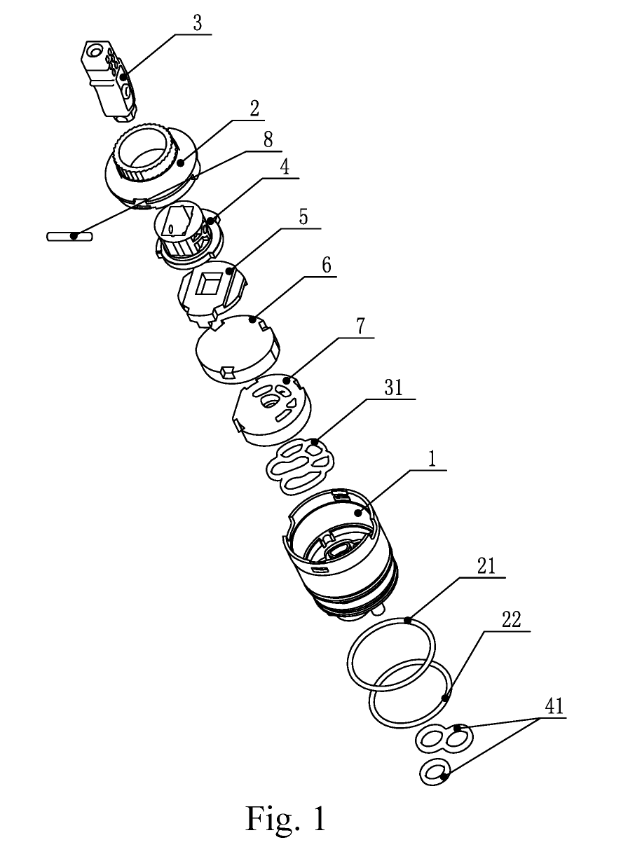

### DETAILED DESCRIPTION OF THE INVENTION

A multi-function valve core with a drinking water control function comprises a housing 1, an upper cover 2, a handle 3, a rotor 4, a drive plate 5, a movable ceramic disc 6 and a stationary ceramic disc 7, wherein the housing 1 and the upper cover 2 are clamped together by a clamping buckle to form a housing assembly of the valve core, the handle 3, the rotor 4, the drive plate 5, the movable ceramic disc 6 and the stationary ceramic disc 7 are mounted in the housing assembly, a lower end of the handle 3 is mounted in the rotor 4, the handle 3 is connected with the rotor 4 via a pin 8, an upper end of the handle 3 protrudes from a cover hole in the middle of the upper cover 2, the rotor 4 is connected with the drive plate 5, the drive plate 5 and the movable ceramic disc 6 are clamped together, the stationary ceramic disc 7 is mounted below the movable ceramic disc 6, the stationary ceramic disc 7 is clamped into the housing 1, the housing 1 and the stationary ceramic disc 7 are respectively provided with a hot water inlet hole 7-1, a cold water inlet hole 7-2, a mixed cold and hot water outlet hole 7-3, a drinking water inlet hole 7-5 and a drinking water outlet hole 7-4 at corresponding positions, the movable ceramic disc 6 is provided with a first cavity 6-1 and a second cavity 6-2, the first cavity 6-1 is communicated with the drinking water inlet hole 7-4 and the drinking water outlet hole 7-5, the second cavity 6-2 is communicated with the hot water inlet hole 7-1, the cold water inlet hole 7-2 and the mixed cold and hot water outlet hole 7-3, the drive plate 5 is provided with a first drive plate limiting surface 5-1, a second drive plate limiting surface 5-2 and a drive plate bar-shaped boss 5-3, the rotor 4 is provided with a first rotor limiting surface 4-1, a second rotor limiting surface 4-2 and a rotor bar-shaped clamping slot 4-3, the upper cover 2 is provided with a first upper cover limiting surface 2-1, a second upper cover limiting surface 2-2 and a third upper cover limiting surface 2-3, and the rotor 4, the drive plate 5 and the upper cover 2 cooperate with each other to limit the rotation angle of the valve core.

The housing 1 is externally sleeved with an upper O-ring 21 and a lower O-ring 22 and internally provided with three stationary ceramic disc bosses for positioning the stationary ceramic disc 7, two positioning posts 1-1 are arranged at the bottom of the housing 1, a sealing ring assembly 41 is arranged at the bottom of the housing 1, the housing 1 is internally provided with an inner sealing washer 31, and the inner sealing washer 31 is placed in a groove inside the housing 1.

The stationary ceramic disc 7 is provided with stationary ceramic disc positioning slots corresponding to the stationary ceramic disc bosses, the stationary ceramic disc bosses are clamped into the stationary ceramic disc positioning slots, and the shape of the inner sealing washer 31 corresponds to that of the stationary ceramic disc 7.

The movable ceramic disc 6 is provided with three movable ceramic disc positioning grooves, movable ceramic disc bosses on the drive plate 5 extend into the movable ceramic disc positioning grooves, and the movable ceramic disc 6 is rotated along with the drive plate 5.

The first drive plate limiting surface 5-1 cooperates with the second upper cover limiting surface 2-2 and the second drive plate limiting surface 5-2 cooperates with the third upper cover limiting surface 2-3 to limit the rotation angle of the valve core; and the drive plate bar-shaped boss 5-3 cooperates with the rotor bar-shaped clamping slot 4-3, the drive plate 5 is provided with a handle positioning hole, a shifting head on the handle 3 is clamped into the handle positioning hole, and the handle 3 drives the drive plate 5 to move linearly in the rotor bar-shaped clamping slot 4-3 on the rotor 4, or to move circularly along with the rotor 4 when driven by the rotor 4.

The rotor 4 is driven by the handle 3 to move circularly in the cover hole of the upper cover 2.

The first upper cover limiting surface 2-1, the second upper cover limiting surface 2-2 and the third upper cover limiting surface 2-3 are located on different planes; and the first upper cover limiting surface 2-1 cooperates with the first rotor limiting surface 4-1, the second upper cover limiting surface 2-2 cooperates with the second rotor limiting surface 4-2, the second upper cover limiting surface 2-2 cooperates with the first drive plate limiting surface 5-1 and the third upper cover limiting surface 2-3 cooperates with the second drive plate limiting surface 5-2 to limit the rotation angle of the valve core.

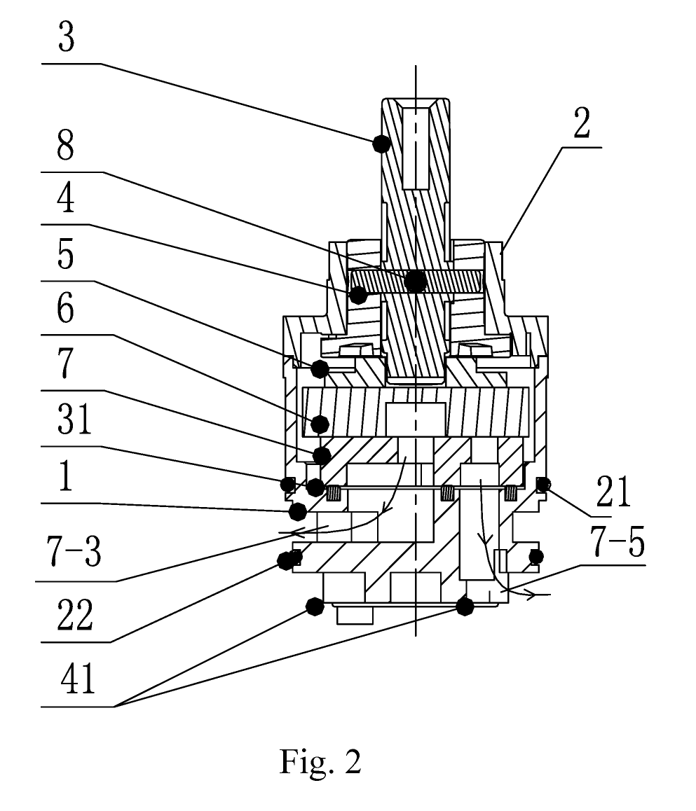

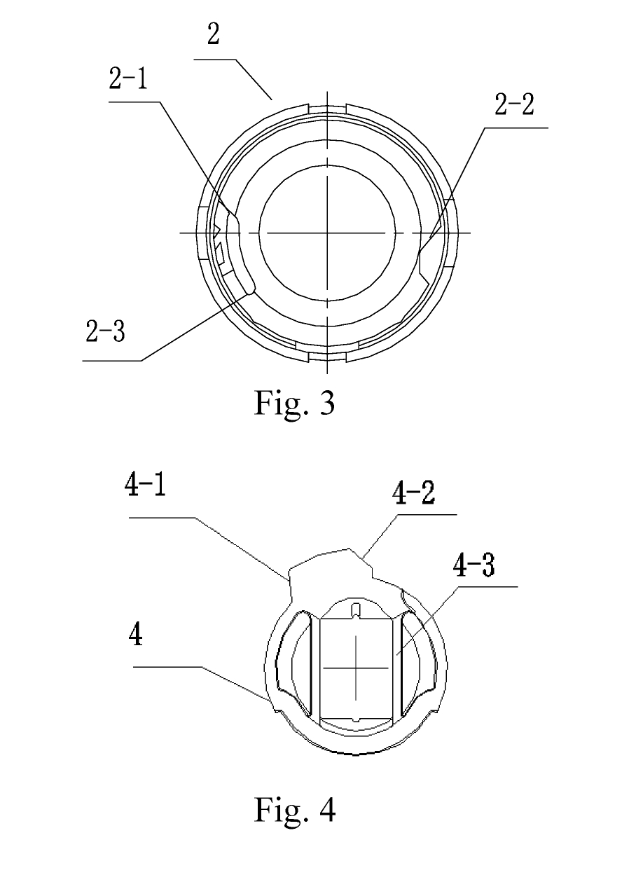

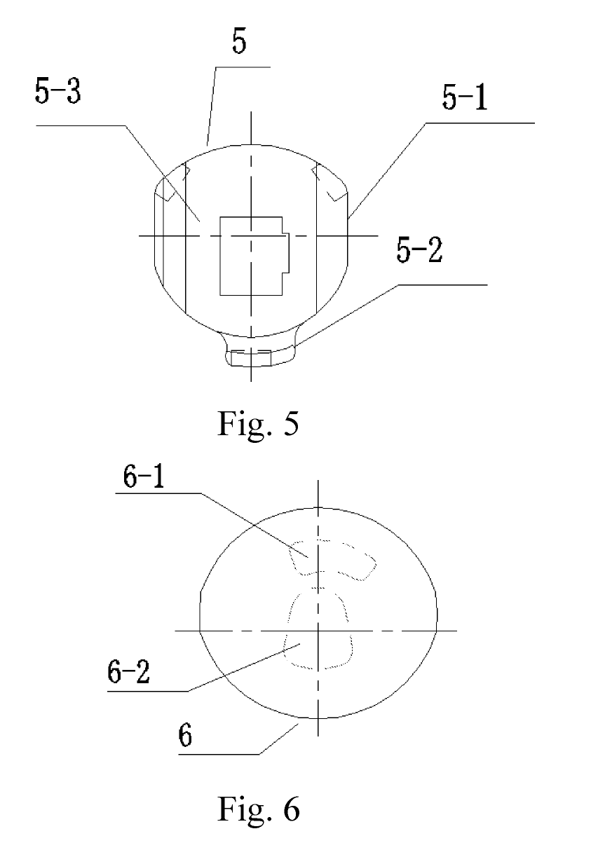

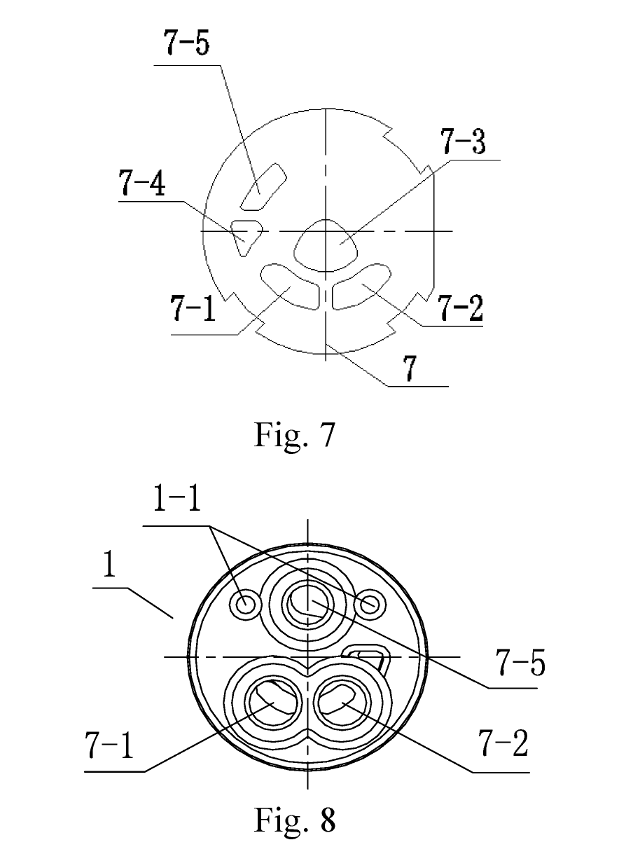

The entire product is provided with three water inlet holes (the hot water inlet hole 7-1, the cold water inlet hole 7-2 and the drinking water inlet hole 7-5, respectively) at the bottom thereof (as shown in FIG. 8), and two water outlet holes (the mixed cold and hot water outlet hole 7-3 and the drinking water outlet hole 7-4, respectively) at a side edge thereof (as shown in FIG. 2).

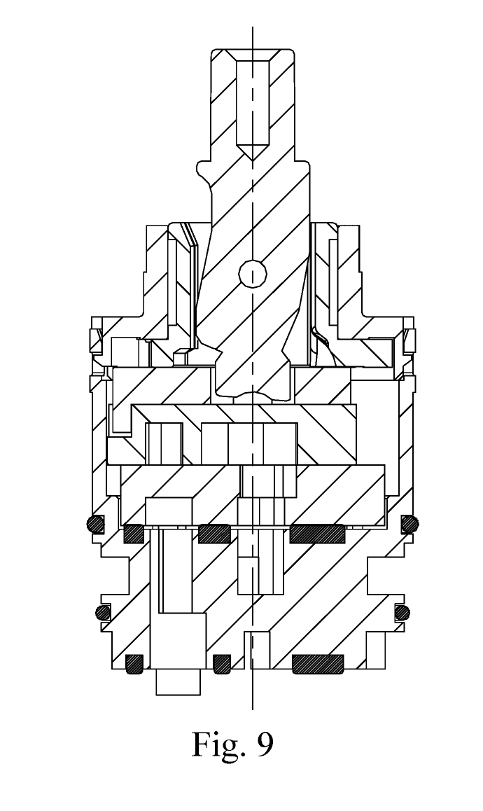

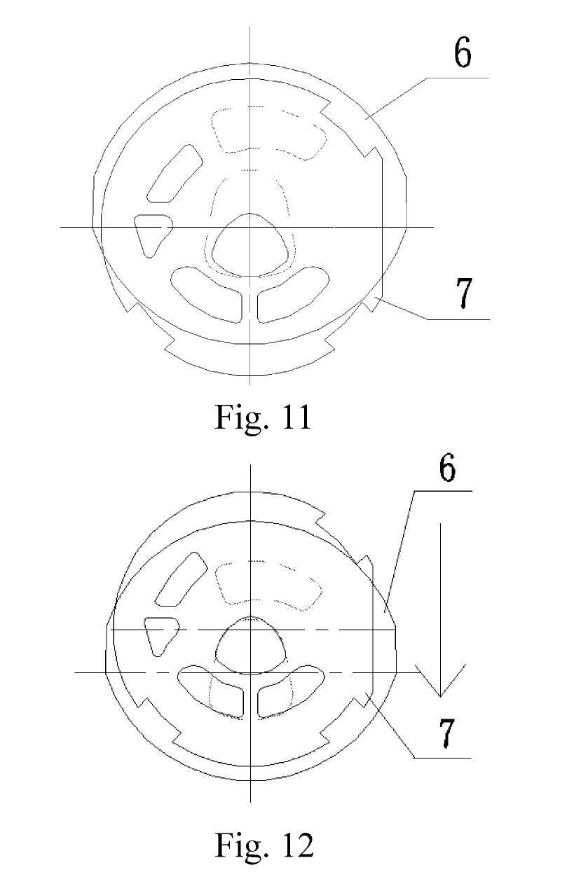

The valve core is in a closed state, as shown in FIG. 9 (wherein the relative position of the movable ceramic disc 6 and the stationary ceramic disc 7 is as shown in FIG. 11).

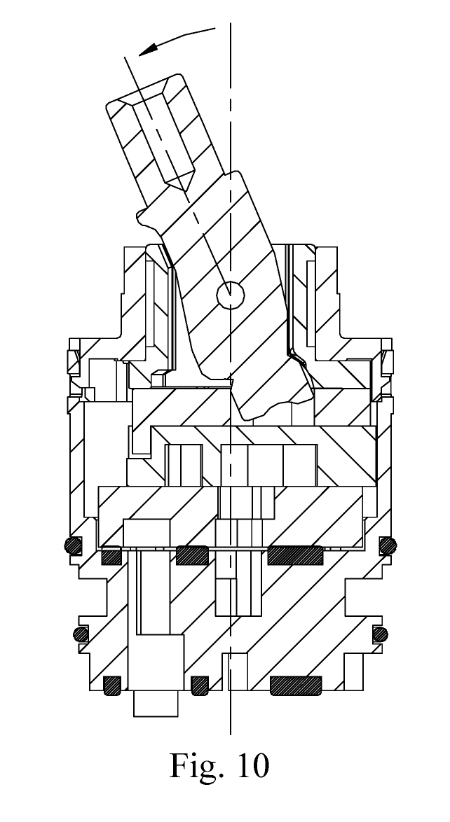

The valve core is in an opened state, as shown in FIG. 10 (wherein the relative position of the movable ceramic disc 6 and the stationary ceramic disc 7 is as shown in FIG. 12).

When the valve core is opened, the handle 3 is rotated by 23° to drive the drive plate 5 and the movable ceramic disc 6 to move, such that the second cavity 6-2 on the movable ceramic disc 6 is communicated with the hot water inlet hole 7-1, the cold water inlet hole 7-2 and the mixed cold and hot water outlet hole 7-3 on the stationary ceramic disc 7, and mixed cold and hot water is discharged from the valve core.

In an opened state, the handle can be rotated by 40° counterclockwise and clockwise respectively, more and more cold water is discharged by counterclockwise rotation while more and more hot water is discharged by clockwise rotation.

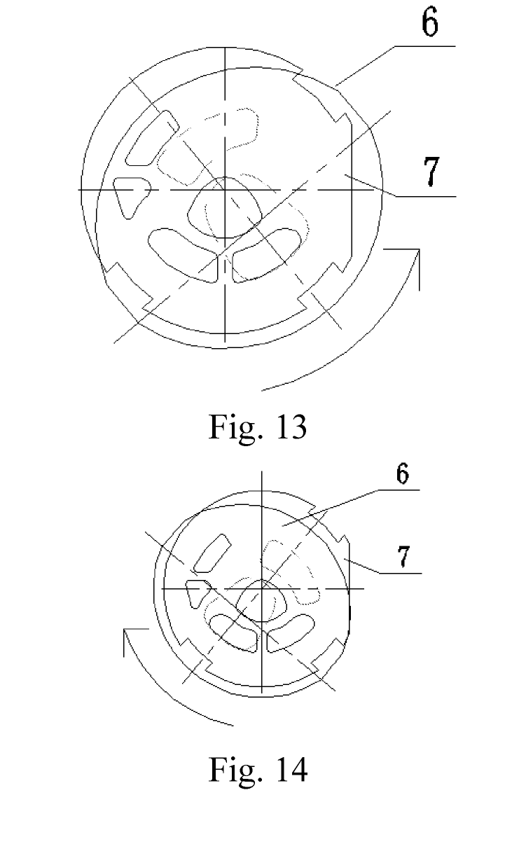

When the handle 3 is rotated counterclockwise to a maximum angle of 40°, the second cavity 6-2 on the movable ceramic disc 6 is only communicated with the cold water inlet hole 7-2 and the mixed cold and hot water outlet hole 7-3 on the stationary ceramic disc 7, the hot water inlet hole 7-1 is cut off, and the relative position of the movable ceramic disc 6 and the stationary ceramic disc 7 is as shown in FIG. 13.

When the handle 3 is rotated clockwise to a maximum angle of 40°, the second cavity 6-2 on the movable ceramic disc is only communicated with the hot water inlet hole 7-2 and the mixed cold and hot water outlet hole 7-3 on the stationary ceramic disc 7, the cold water inlet hole 7-2 is cut off, and the relative position of the movable ceramic disc 6 and the stationary ceramic disc 7 is as shown in FIG. 14.

When the valve core is opened, regardless of clockwise rotation or counterclockwise rotation, the drinking water inlet hole 7-4 and the drinking water outlet hole 7-5 on the stationary ceramic disc are cut off.

After the valve core is opened, clockwise and counterclockwise rotation to a maximum angle is limited by cooperation among the respective limiting surfaces on the drive plate 5, the rotor 4 and the upper cover 2.

When the handle 3 is rotated counterclockwise to a maximum angle of 40°, the first drive plate limiting surface 5-1 and the second upper cover limiting surface 2-2 cooperate with each other to control the counterclockwise rotation to the maximum angle.

When the handle 3 is rotated clockwise to a maximum angle of 40°, the first rotor limiting surface 4-1 and the first upper cover limiting surface 2-1 cooperate with each other to control the clockwise rotation to the maximum angle.

When the valve core is in a closed state, the handle can still be rotated by 40° clockwise and counterclockwise respectively, and the valve core remains in a closed state in which no water is discharged.

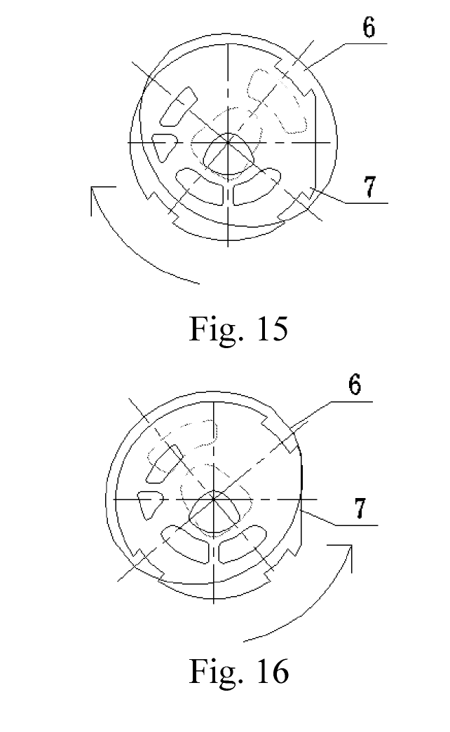

FIG. 15 is a schematic view of the positional relation of hole sites of the movable ceramic disc 6 and the stationary ceramic disc 7 when the handle 3 is rotated clockwise to a maximum angle of 40° (the valve core is in a closed state), wherein the hole sites are cut off.

FIG. 16 is a schematic view of the positional relation of hole sites of the movable ceramic disc 6 and the stationary ceramic disc 7 when the handle 3 is rotated counterclockwise to a maximum angle of 40° (the valve core is in a closed state), wherein the hole sites are cut off.

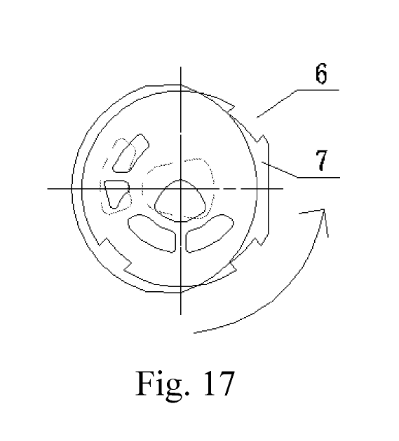

As shown in FIG. 17, when the handle 3 is rotated counterclockwise by 90° (the handle should continue to rotate beyond a range of 40°), the drinking water inlet hole 7-5 and the drinking water outlet hole 7-4 are communicated by the first cavity 6-1, drinking water is discharged and other hole sites are cut off.

When the valve core is in a closed state, its rotation angle is still controlled by cooperation among the limiting surfaces of the drive plate 5, the rotor 4 and the upper cover 2.

When the handle 3 is rotated clockwise to a maximum angle of 40° (the position of maximum hot water), the first rotor limiting surface 4-1 contacts the first upper cover limiting surface 2-1 to control the clockwise rotation to the maximum angle.

When the handle 3 is rotated counterclockwise to a maximum angle of 40° (the position of maximum cold water), the second drive plate limiting surface 5-2 contacts the third upper cover limiting surface 2-3 to control the counterclockwise rotation to the maximum angle.

The third upper cover limiting surface 2-3 is a clamping position limiting surface, the handle 3 can be rotated over the clamping position by tiny force and continue to rotate to 90° (in a drinking water state), and then the second rotor limiting surface 4-2 contacts the second upper cover limiting surface 2-2 to control the rotation within 90°.

The housing 1 is externally sleeved with an upper O-ring 21 and a lower O-ring 22.

An inner sealing washer 31 is mounted between the stationary ceramic disc 7 and the housing 1, and the shape of the inner sealing washer 31 corresponds to that of the stationary ceramic disc 7.

The housing 1 is internally provided with three stationary ceramic disc bosses for positioning the stationary ceramic disc 7, the stationary ceramic disc 7 is provided with stationary ceramic disc positioning slots corresponding to the stationary ceramic disc bosses, two positioning posts 1-1 are arranged at the bottom of the housing 1, and a sealing ring assembly 41 is arranged at the bottom of the housing 1

The movable ceramic disc 6 is provided with a first cavity 6-1 and a second cavity 6-2, the first cavity 6-1 is communicated with the drinking water inlet hole 7-5 and the drinking water outlet hole 7-4, and the second cavity 6-2 is communicated with the hot water inlet hole 7-1, the cold water inlet hole 7-2 and the mixed cold and hot water outlet hole 7-3.

The movable ceramic disc 6 is provided with three movable ceramic disc positioning grooves, the drive plate 5 is provided with movable ceramic disc bosses corresponding to the movable ceramic disc positioning grooves, the movable ceramic disc bosses are clamped into the movable ceramic disc positioning grooves, and the movable ceramic disc 6 is rotated along with the drive plate 5.

The drive plate 5 is provided with a first drive plate limiting surface 5-1, a second drive plate limiting surface 5-2 and a drive plate bar-shaped boss 5-3, the rotor 4 is provided with a first rotor limiting surface 4-1, a second rotor limiting surface 4-2 and a rotor bar-shaped clamping slot 4-3, and the upper cover 2 is provided with a first upper cover limiting surface 2-1, a second upper cover limiting surface 2-2 and a third upper cover limiting surface 2-3. The first upper cover limiting surface 2-1, the second upper cover limiting surface 2-2 and the third upper cover limiting surface 2-3 are located on different planes.

The rotor bar-shaped clamping slot 4-3 arranged on the rotor 4 cooperates with the drive plate bar-shaped boss 5-3 to drive the rotation of the drive plate 5, and meanwhile the drive plate bar-shaped boss 5-3 can move linearly in the rotor bar-shaped clamping slot 4-3.

When cold and hot water are normally discharged by the product, more and more hot water is discharged when the handle 3 is rotated clockwise, while more and more cold water is discharged when the handle is rotated counterclockwise. When drinking water is needed, the valve core in a closed state can be rotated counterclockwise by 90° to discharge drinking water.

The above description is only an embodiment of the invention, and does not constitute a limitation on the protection scope of the invention. All the equivalent structural or process transformations conducted according to the description and the accompanying drawings of the product, or directly or indirectly used in other relevant technical fields, should similarly be included in the protection scope of the patent application.

1. A multi-function valve core with a drinking water control function, comprising a housing (1), an upper cover (2), a handle (3), a rotor (4), a drive plate (5), a movable ceramic disc (6) and a stationary ceramic disc (7), wherein the housing (1) and the upper cover (2) are clamped together by a clamping buckle to form a housing assembly of the valve core, the handle (3), the rotor (4), the drive plate (5), the movable ceramic disc (6) and the stationary ceramic disc (7) are mounted in the housing assembly, a lower end of the handle (3) is mounted in the rotor (4), the handle (3) is connected with the rotor (4) via a pin (8), an upper end of the handle (3) protrudes from a cover hole in the middle of the upper cover (2), the rotor (4) is connected with the drive plate (5), the drive plate (5) and the movable ceramic disc (6) are clamped together, the stationary ceramic disc (7) is mounted below the movable ceramic disc (6), the stationary ceramic disc (7) is clamped into the housing (1), the housing (1) and the stationary ceramic disc (7) are respectively provided with a hot water inlet hole (7-1), a cold water inlet hole (7-2), a mixed cold and hot water outlet hole (7-3), a drinking water inlet hole (7-5) and a drinking water outlet hole (7-4) at corresponding positions, the movable ceramic disc (6) is provided with a first cavity (6-1) and a second cavity (6-2), the first cavity (6-1) is communicated with the drinking water inlet hole (7-4) and the drinking water outlet hole (7-5), the second cavity (6-2) is communicated with the hot water inlet hole (7-1), the cold water inlet hole (7-2) and the mixed cold and hot water outlet hole (7-3), the drive plate (5) is provided with a first drive plate limiting surface (5-1), a second drive plate limiting surface (5-2) and a drive plate bar-shaped boss (5-3), the rotor (4) is provided with a first rotor limiting surface (4-1), a second rotor limiting surface (4-2) and a rotor bar-shaped clamping slot (4-3), the upper cover (2) is provided with a first upper cover limiting surface (2-1), a second upper cover limiting surface (2-2) and a third upper cover limiting surface (2-3), and the rotor (4), the drive plate (5) and the upper cover (2) cooperate with each other to limit the rotation angle of the valve core.

2. The multi-function valve core with a drinking water control function according to claim 1, wherein the housing (1) is externally sleeved with an upper O-ring (21) and a lower O-ring (22) and internally provided with three stationary ceramic disc bosses for positioning the stationary ceramic disc (7), two positioning posts (1-1) are arranged at the bottom of the housing (1), a sealing ring assembly (41) is arranged at the bottom of the housing (1), the housing (1) is internally provided with an inner sealing washer (31), and the inner sealing washer (31) is placed in a groove inside the housing (1).

3. The multi-function valve core with a drinking water control function according to claim 2, wherein the stationary ceramic disc (7) is provided with stationary ceramic disc positioning slots corresponding to the stationary ceramic disc bosses, the stationary ceramic disc bosses are clamped into the stationary ceramic disc positioning slots, and the shape of the inner sealing washer (31) corresponds to that of the stationary ceramic disc (7).

4. The multi-function valve core with a drinking water control function according to claim 3, wherein the movable ceramic disc (6) is provided with three movable ceramic disc positioning grooves, movable ceramic disc bosses on the drive plate (5) extend into the movable ceramic disc positioning grooves, and the movable ceramic disc (6) is rotated along with the drive plate (5).

5. The multi-function valve core with a drinking water control function according to claim 4, wherein the first drive plate limiting surface (5-1) cooperates with the second upper cover limiting surface (2-2) and the second drive plate limiting surface (5-2) cooperates with the third upper cover limiting surface (2-3) to limit the rotation angle of the valve core; and the drive plate bar-shaped boss (5-3) cooperates with the rotor bar-shaped clamping slot (4-3), the drive plate (5) is provided with a handle positioning hole, a shifting head on the handle (3) is clamped into the handle positioning hole, and the handle (3) drives the drive plate (5) to move linearly in the rotor bar-shaped clamping slot (4-3) on the rotor (4), or to move circularly along with the rotor (4) when driven by the rotor (4).

6. The multi-function valve core with a drinking water control function according to claim 5, wherein the rotor (4) is driven by the handle (3) to move circularly in the cover hole of the upper cover (2).

7. The multi-function valve core with a drinking water control function according to claim 6, wherein the first upper cover limiting surface (2-1), the second upper cover limiting surface (2-2) and the third upper cover limiting surface (2-3) are located on different planes; and the first upper cover limiting surface (2-1) cooperates with the first rotor limiting surface (4-1), the second upper cover limiting surface (2-2) cooperates with the second rotor limiting surface (4-2), the second upper cover limiting surface (2-2) cooperates with the first drive plate limiting surface (5-1) and the third upper cover limiting surface (2-3) cooperates with the second drive plate limiting surface (5-2) to limit the rotation angle of the valve core.
